(19) United States
(12) Patent Application Publication
(10) Pub. No.: US 2024/0109990 A1
(43) Pub. Date: Apr. 4, 2024

(54) AN AQUEOUS POLYMER DISPERSION

(71) Applicant: Wacker Chemie AG, Munich (DE)

(72) Inventors: Jin Zheng, Shanghai (CN); Qian Chen, Shanghai (CN); Yipeng Wei, Shanghai (CN); Jiaxiang Zhou, Shanghai (CN)

(73) Assignee: Wacker Chemie AG, Munich (DE)

(21) Appl. No.: 18/265,692

(22) PCT Filed: Dec. 30, 2020
(86) PCT No.: PCT/CN2020/141295

§ 371 Date: Jun. 7, 2023

(51) Int. Cl. C08F 218/08; C09J 123/08

(52) U.S. Cl. CPC C08F 218/08; C09J 123/0853

(57) ABSTRACT

Aqueous dispersions and uses for the same. The aqueous dispersion includes a component (a) of one or more ethylene-vinyl ester copolymers and a component (b) of one or more protective colloids. The aqueous dispersion may optionally a component (c1) of one or more nonionic surfactants and/or a component (c2) of one or more ionic surfactants. Where a total amount of the component (b) is less than or equal to 2.2 pphm, preferably between 1-2.2 pphm, or more preferably 1.8 pphm. Additionally, where a total amount of the component (c1) and the component (c2) is less than 0.1 pphm, preferably less than or equal to 0.01 pphm.

### FIELD OF THE INVENTION

The present invention relates to an aqueous polymer dispersion and use thereof for interfacial bonding between polymeric porous materials.

Commercial VINNAPAS® 192 CGN is a self-crosslinking aqueous polymer dispersion based on ethylene-vinyl acetate. This product can be crosslinked at 150° C. for bonding in the production of nonwovens. The recommended use of the product is: prior to use, adding 1% catalyst (based on the solids content of VINNAPAS® 192 CGN) to the product and mix well. The catalyst is generally formulated as a 10% aqueous solution. Among the commonly used are ammonium chloride, citric acid and sodium bisulfate. If the time for mixing VINNAPAS® 192 CGN with the catalyst is too long and exceeds thirty minutes under room temperature, the mixture will gel, leading to a significantly increased viscosity that renders it unusable.

CN102869828B discloses a VAE aqueous dispersion for carpet bonding. The amount of protective colloid is less than 1 pphm, and the sum of the amount of nonionic surfactant and anionic surfactant is between 2-4 pphm. This product has poor water resistance.

CN102333799B discloses a VAE aqueous dispersion, which is suitable for the bonding application of paper products, plastics, textiles and fiber materials; in Example 41, the amount of hydroxyethyl cellulose HEC is 1.1 pphm, and the amount of non-ionic surfactant is 2.0 pphm.

CN104411488B discloses a VAE aqueous dispersion for paper bonding. In Example 6, the amount of polyvinyl alcohol is 0.2 pphm, the amount of anionic surfactant is 0.5 pphm, and the amount of non-ionic surfactant is 3 pphm.

### SUMMARY OF THE INVENTION

In the prior art, there is no binder product containing VAE emulsion with excellent water resistance.

The invention obtains an aqueous polymer dispersion, which has high wet bonding strength and excellent water resistance. It has the advantages of long-term storage at room temperature and good viscosity stability. And the polymer aqueous dispersion is particularly suitable for bonding between polymer interface materials, and more suitable for bonding between fiber textile materials and polymer foam materials.

As used herein, the term “pphm” refers to parts per hundred main monomer, i.e., parts per hundred of the vinyl acetate and ethylene.

An aqueous polymer dispersion containing

Component (a) one or more ethylene-vinyl ester copolymers,

Component (b) one or more protective colloids,

optional component (c1) one or more nonionic surfactants, and

optional component (c2) one or more ionic surfactants,

wherein the component (b) protective colloid is less than or equal to 3.4 pphm, for example 1.8 pphm, 2.2 pphm, 2.4 pphm, 2.6 pphm, 2.8 pphm, 3 pphm, 3.2 pphm, preferably between 1-3.4 pphm, more preferably between 2-3.1 pphm, more preferably between 2.3-2.9 pphm;

wherein, the total amount of component (c1) nonionic surfactant and component (c2) ionic surfactant is less than 0.1 pphm, preferably less than or equal to 0.01 pphm.

The aqueous dispersion as described above, wherein the component (b) protective colloid containing the component (b1) partially hydrolysis polyvinyl alcohol and the component (b2) fully hydrolysis polyvinyl alcohol.

The aqueous dispersion as described above, wherein the total amount of component (b1) partially hydrolysis polyvinyl alcohol and component (b2) fully hydrolysis polyvinyl alcohol is less than or equal to 3.4 pphm, such as 1.6 pphm, 1.8 pphm, 2.2 pphm, 2.4 pphm, 2.6 pphm, 2.8 pphm, 3 pphm, 3.2 pphm, preferably between 1-3.4 pphm, more preferably between 2-3.1 pphm, and more preferably between 2.3-2.9 pphm.

The aqueous dispersion as described above, wherein the weight ratio of the amount of component (b1) partially hydrolysis polyvinyl alcohol to component (b2) fully hydrolysis polyvinyl alcohol is between 0.8-4, preferably between 1.01-3, more preferably between 1.05-1.9, such as 1.1, 1.2, 1.3, 1.4, 1.8, 2.0, 2.2, 2.4.

The aqueous dispersion as described above, wherein the amount of polyvinyl alcohol PVOH is greater than 50 wt %, preferably greater than or equal to 65 wt %, more preferably greater than or equal to 75 wt %, more preferably greater than or equal to 85 wt %, more preferably greater than or equal to 95 wt %, based on the total amount of component (b) protective colloid as 100 wt %.

The aqueous dispersion as described above, wherein the amount of the partially hydrolysis polyvinyl alcohol of component (b1) is less than or equal to 2 pphm, preferably less than or equal to 1.6 pphm, and more preferably between 1.1-1.7 pphm, such as 1.8, 1.4, 1.2, 1.0 pphm.

The aqueous dispersion as described above, wherein the amount of component (b2) fully hydrolysis polyvinyl alcohol is less than or equal to 1.5 pphm, preferably less than or equal to 1.3 pphm, more preferably between 0.3-1.1 pphm, such as 0.4, 0.6, 0.8, 0.9 pphm.

In the present invention, partially hydrolysis polyvinyl alcohol refers to a product with a degree of hydrolysis between 87-89%, and fully hydrolysis polyvinyl alcohol refers to a product with a degree of hydrolysis between 98-100%.

The aqueous dispersion as described above, wherein component (b1) partially hydrolysis of polyvinyl alcohol, the viscosity of its 4 wt % aqueous solution measured according to DIN 53015 at 20° C. is between 20-28 mPa·s, preferably between 21-27 mPa·s.

The above-mentioned aqueous dispersion, component (b2) fully hydrolysis polyvinyl alcohol, the viscosity of its 4 wt % aqueous solution at 20° C. measured according to DIN 53015 is between 15-18 mPa·s, preferably between 16-17 mPa·s.

The aqueous dispersion as described above, wherein PVOH refers to polyvinyl alcohol, the viscosity of a 4 wt % aqueous solution measured according to DIN 53015 at 20° C. is between 3-5 mPa·s or 15-18 mPa·s or 20-28 mPa·s, for example, these products are commonly referred to as PVOH04/88, PVOH17/88, PVOH25/88.

The aqueous dispersion as described above, wherein the amount of sodium vinyl sulfonate is less than 0.5 pphm, preferably less than or equal to 0.1 pphm, and more preferably less than 0.01 pphm.

The aqueous dispersion as described above, wherein the dispersion further containing component (f) one or more thickeners, the dosage of which is less than or equal to 1 pphm, preferably less than or equal to 0.2 pphm, more preferably less than or equal to 0.5 pphm, more preferably between 0.05-0.2 pphm, such as 0.08, 0.1, 0.12, 0.14, 0.16, 0.18 pphm.

In the present invention, the component (f) thickeners containing component (f1) which consisting of ASE (alkali swellable emulsion) thickener and HASE (hydrophobic modified alkali swellable emulsion) thickener, and component (f2) natural polymers and their derivatives.

The aqueous dispersion as described above, wherein component (f) is component (f1), which consisting of ASE (alkali swellable emulsion) thickener and HASE (hydrophobic modified Alkali swellable emulsion) thickener composition; preferably ASE thickener which containing acrylamide and/or acrylic monomer; or preferably HASE thickener which containing acrylamide and/or acrylic monomer.

There are 2 major families of alkali swellable acrylic thickeners: thickeners of the ASE (Alkali Swellable Emulsion) type and those of HASE (Hydrophobically modified Alkali Swellable Emulsion) type. The first designate copolymers of methacrylic acid with a non-water soluble ester of this acid, and the second designate methacrylic acid based copolymers of a non-water soluble ester of the (meth)acrylic acid and a monomer with so-called “associative” hydrophobic groups. In addition, these copolymers can be cross-linked.

The aqueous dispersion as described above, which is a product in a single package.

The aqueous dispersion as described above, wherein in the component (a) ethylene-vinyl ester copolymer, the amount of vinyl ester monomer is greater than or equal to 70 wt %, preferably greater than or equal to 80 wt %, more preferably between 80-90 wt %, more preferably between 82-88 wt %, based on 100 wt % of all monomers.

The aqueous dispersion as described above, wherein in the component (a) ethylene-vinyl ester copolymer, the amount of ethylene monomer is less than or equal to 30 wt %, preferably between 10-20 wt %, more preferably between 12-18 wt %, based on 100 wt % of all monomers.

The aqueous dispersion as mentioned above, wherein the amount of vinyl acetate and ethylene in Component (a) is greater than or equal to 95 wt %, preferably greater than or equal to 98 wt %, more preferably greater than or equal to 99 wt %, more preferably greater than or equal to 99.9 wt %, based on the 100 wt % of Component (a).

The aqueous dispersion as mentioned above, wherein the monomers in Component (a) are vinyl acetate and ethylene.

The aqueous dispersion as mentioned above, wherein the weight ratio of the component (a) ethylene-vinyl ester copolymer to the total amount of all polymers and copolymers in the composition is 0.8 or more, preferably 0.9 or more, more preferably 0.95 or more.

The aqueous dispersion as described above, wherein the component (a) ethylene-vinyl ester copolymer is an ethylene-vinyl acetate copolymer.

The aqueous dispersion as mentioned above, wherein the aqueous polymer dispersion is an emulsion having a Brookfield viscosity between 3,000 and 12,000 mPa-s, preferably between 5,000 and 8,000 mPa-s, as measured according to the ST-2 Brookfield viscosity test method and having a rate of change in Brookfield viscosity of less than 100 wt %, preferably less than 30%, more preferably less than 10%, after 60 days of storage at 23° C.; preferably a rate of change in Brookfield viscosity of less than 100 wt %, after 14 days of storage at 50° C.

The aqueous dispersion as described above, wherein the solid content of which is between 49-66 wt %, preferably between 53-63 wt %; more preferably between 54-60 wt %. For example, 55 wt %, 56 wt %, 57 wt %, 58 wt %, 59 wt %.

The aqueous dispersion as described above, wherein the amount of the optional component (a′) Other copolymers are less than or equal to 1 wt %, preferably less than or equal to 0.1 wt %, and the aqueous dispersion is calculated as 100 wt %, and component (a′) Other copolymers contains vinyl acrylic copolymers, styrene acrylate copolymers, styrene butadiene copolymers, acrylic polymers, and vinyl acetate homopolymers.

Use of the aqueous dispersion as described above for interfacial bonding between polymeric porous materials

The use as mentioned above, wherein aqueous dispersion is used to improve water resistance at the bonding interface of polymer porous materials.

The use as mentioned above, wherein aqueous dispersion is used to improve wet bonding strength at the bonding interface of polymer porous materials.

The improved water resistance effect refers to the definition of wet bonding strength according to the wet bonding strength in the test part of the present invention.

wherein the interfacial bonding between polymeric porous materials is that between one type or more types of materials selected from among fiber textile materials and polymeric foamed materials, preferably that between one type or more types of materials selected from the group consisting of synthetic fiber textile materials, synthetic fiber non-woven materials, natural fiber textile materials, natural fiber non-woven materials, regenerated cellulose materials, ethylene-vinyl acetate (EVA) copolymer foams and polyurethane (PU) foams, more preferably that between that PU foams and synthetic fiber textile materials, or between PU foams and natural fiber textile materials, or between EVA copolymer foams and synthetic fiber textile materials, or between EVA copolymer foams and natural fiber textile materials.

Use of the aqueous dispersion as mentioned above for bonding between textile materials and non-woven materials.

The use as described above, wherein Tg of the aqueous dispersion is between 0-5° C., preferably between 0-4° C., more preferably between 0-2° C.

A composite structure for insoles, comprising an artificial fiber textile material and a polymeric foamed material, which are held in place by bonding with the aforesaid aqueous dispersion.

Composite products are obtained in such a way that polymeric porous materials are interfacially bonded. Some of them often come into contact with water during use, or frequently need to be cleaned. Use fields of these composites containing, for example, shoe liners, shoe inserts and sportswear. Composite products with poor water resistance are prone to degumming in contact with water, that is, interface debonding, leading to a short service life.

According to the use as described above, the interfacial bonding between polymeric porous materials is preferably the lamination of an artificial fiber textile material onto a polymeric foamed material.

According to the use as described above, the interfacial bonding between polymeric porous materials is preferably that between polyester or acrylic or cotton textile materials and EVA copolymer foams.

According to the use as described above, the interfacial bonding between cotton textile materials and cotton textile materials.

According to the use as described above, the aqueous polymer dispersion is applied onto the surfaces of the polymeric porous materials to be bonded, the resulting product being exposed to a heat source for a period of time.

According to the use as described above, the interfacial bonding between polymeric porous materials does not include the production of polymeric porous materials themselves using a binder, which mainly refers to the bonding together of fibrous polymer materials less than 5 mm in diameter. For example, in the process of manufacturing non-woven, a binder is used to form non-woven fabrics by bonding together the fibrous materials such as wood pulp fibers, rayon, cottons, wools and acetate fibers; or in the process of paper making, a binder is used to form paper webs, papers or cardboards by bonding pulp fibers together.

According to the use as described above, the aqueous polymer dispersion is applied onto the surfaces of the polymeric porous materials to be bonded, the resulting product being exposed to a heat source, at between 100 and 200° C., for a period of time between 25 and 120 seconds to complete the drying step.

According to the use as described above, the aqueous polymer dispersion is applied onto the surfaces of the polymeric porous materials to be bonded using a roll coater with a certain pressure, and simultaneously completing the drying step therein.

According to the use as described above, after the drying step is completed using the roll coater, no further hot press treatment is required.

According to the use as described above, the coat weight of the aqueous polymer dispersion is between 120 and 210 g/m 2.

When the viscosity of the aqueous polymer dispersion is too low, the coating roller takes up a small amount of glue during the production, leading to a poor bonding effect of the product; while the viscosity of the aqueous polymer dispersion is too high, the coating roller takes up a large amount of glue, leading to excessive coat weight in the product and high consumption of the aqueous polymer dispersion and thus to diseconomy.

The vinyl esters typically include vinyl esters of linear or branched alkyl carboxylic acids having 1 to 15 carbon atoms, such as vinyl acetate, vinyl propionate, vinyl butyrate, vinyl pivalate, Vinyl 2-ethylhexanoate, vinyl laurate, or any combination of the above.

In order to extend the performance of component (a) ethylene-vinyl ester copolymer, in addition to vinyl ester and ethylene monomers, other comonomers may be included, such as vinyl halides, such as vinyl chloride; olefins, such as propylene; Ethylene unsaturated carboxylic acids and their derivatives, such as fumaric acid, maleic acid, maleic anhydride, acrylamide, acrylonitrile; pre-crosslinking comonomers or post-crosslinking comonomers, such as adipic acid two Vinyl ester, diallyl maleate, allyl methacrylate, triallyl cyanurate, acrylamido glycolic acid, methyl methacrylamido glycolate, N-methylol Acrylamide, N-methylol methacrylamide, N-methylol allyl carbamate, isobutoxy ether or ester of N-methylol acrylamide, N-methylol methyl propylene Isobutoxy ether or ester of amide, isobutoxy ether or ester of N-methylol allyl carbamate; epoxy functional comonomers, such as glycidyl methacrylate, glycidyl acrylate; Silicone functional comonomers, such as vinyl trialkoxy silane, vinyl methyl dialkoxy silane.

The amount of these other comonomers is less than or equal to 2 wt %, preferably less than or equal to 1 wt %, more preferably less than or equal to 0.1 wt %, and the amount of vinyl ester monomer is calculated as 100 wt %.

The polymers are prepared by the solution polymerization process, emulsion polymerization process or suspension polymerization process, preferably by the emulsion polymerization process, in which the polymerization temperature is generally from 20° C. to 100° C., preferably from 45° C. to 80° C. The polymerization of gaseous monomers, such as ethylene, 1,3-butadiene or vinyl chloride, can also be carried out under a pressure of generally from 5 bar to 100 bar (abs.). The pH range desired for the polymerization, which is in general between 2.5 and 10, preferably between 3 and 8, can be established in a known manner by acids, bases or customary buffer salts, such as alkali metal phosphates or alkali metal carbonates.

The polymerization is initiated by a water-soluble or monomer-soluble initiator or redox initiator combinations customary for emulsion polymerization or suspension polymerization. Examples of water-soluble initiators are the sodium, potassium and ammonium salts of peroxodisulfuric acid, hydrogen peroxide, t-butyl peroxide (e.g. t-butyl hydroperoxide), potassium peroxodisulfate, t-butyl peroxypivalate and azobisisobutyronitrile. These initiators are generally used in an amount of 0.01 to 3% by weight in each case based on the total dry weight of the monomers.

As redox initiators, use is made of combinations of the initiators above-mentioned in combination with reducing agents. Suitable reducing agents are the sulfites of alkali metals or of ammonium, the bisulfites of alkali metals or of ammonium, the derivatives of sulfoxylic acid of alkali metals or of ammonium, or sulfinates of alkali metals or of ammonium. The amount of said reducing agent is generally from 0.01 to 3% by weight in each case based on the total dry weight of the monomers of Component (a).

To control the molecular weight, regulating substances can be used during the polymerization. If regulators are used, they are usually employed in amounts of from 0.01 to 5.0% by weight, based on the total dry weight of the monomers of Component (a), and are introduced separately or premixed with reaction components. Examples of such substances are n-dodecyl mercaptan, t-dodecyl mercaptan, mercaptopropionic acid, methyl mercaptopropionate, isopropanol and acetaldehyde.

Suitable protective colloids for the polymerization are polyvinyl alcohols; polyvinyl acetals; polyvinylpyrrolidones; polysaccharides in water-soluble form, e.g. starches (amylose and amylopectin), celluloses and their carboxymethyl, methyl, hydroxyethyl, hydroxypropyl derivatives, dextrins and cyclodextrins.

The polymerization can be carried out successively or continuously.

After conclusion of the polymerization, an post-polymerization can be carried out to remove residual monomers using known methods, in general by means of an post-polymerization initiated by a redox catalyst. Volatile residual monomers can also be removed by means of distillation, preferably under reduced pressure, and, if appropriate, with inert entrainer gases such as air, nitrogen or steam being passed through or over the polymerization mixture. The aqueous polymer dispersions obtainable in this way have a solids content of from 40 to 70% by weight.

Defoamers and anti-caking agents can be added to the aqueous polymer dispersions herein for subsequent preparation of water-redispersible polymer powders by means of a traditional process: fluidized-bed drying, freeze drying or spray drying.

### Sample Preparation and Test Method

Sample preparation and method ST-1 for glass transition temperature measurement:

Sample a certain amount of the aqueous polymer dispersion and dry at 25° C. overnight and then let stand in a vacuum oven at 40° C. for 24 hours to obtain an dried polymer product.

Take 8-15 mg of the dry product and heat from −80° C. to 100° C. at a heating rate of 10K/min using NETZSCH F203 analyzer in a closed sample cell in protective nitrogen atmosphere, according to IS011357-1 2014, to determine the glass transition temperature (Tg) of the dried polymer product.

### Method ST-2 for Viscosity Inspection:

The viscosity of the sample is determined with a Brookfield RV/DV rotational viscometer according to GB/T 11175-2002 using spindle No. 4 at 20 rpm at 25° C.

The room temperature conditions in the present invention refer to: a temperature of 23±2° C. and a relative humidity of 65±5%.

### Lab-Scale Sample Preparation Method for Bonding Strength Test:

Cut a piece of polyester fabric and a pice of Polyurethane foam to size 20×15 cm in reference to the test method according to IS011339-2010. Lay the Polyurethane foam on the glass, the upper and lower ends being fixed with 1.8 cm wide 3M electrical tape. Spread the aqueous polymer dispersion over the foam using a doctor blade, scraped tight with a 300-μm scraper bar. Place the foam sample in an oven for heat treatment at 130° C. for 60 s before removing.

Spread another layer of aqueous polymer dispersion on the glass by a 300-μm scraper bar. The polyester fabric is layed on the glass, and pressed twice by a glass rod before removing.

Lay Polyurethane foam on the polyester fabric and press it twice with a 2-kg pressure roller. Place the fabric sample in an oven for heat treatment at 130° C. for a while before removing. The dry fabric sample is prepared.

When it is necessary to test the bonding strength of cotton fabric and cotton fabric, replace the above-mentioned polyester fabric and polyurethane foam with cotton fabric respectively.

### Method ST-3 for Dry Bonding Strength Test:

A dry fabric sample mentioned above is tested for 180° peel strength in reference to the method shown in FIG. 1 of IS011339-2010 on Shandong Labthink XLW (G)-PC smart electronic tensile tester. The sample, with its width remaining 25.4 mm (1 inch), is vertically stretched for a distance of 40 mm. The stretches up to 2 mm at both the beginning and end of the test are not taken into account. The stretching speed is 100 mm/min.

### Method ST-4 for Wet Bonding Strength Test:

Refer to test method ST-3, place the above fabric sample is soaked in 25° C. water for 1 hour, and test the bonding strength of the wet fabric sample immediately.

### DETAILED DESCRIPTION OF THE PREFERRED EMBODIMENTS

The amounts in the present invention are, unless otherwise specified, in parts by weight.

In Tables 1, unless otherwise specified, the part by weight of each raw material are calculated on the basis of 100 parts by weight of the vinyl acetate and ethylene monomers.

In Tables 1, the concentration of a solution is the weight of solute divided by the weight of solution, in the form of percent by weight.

PVOH 04/88 20 wt % aqueous solution, having an hydrolysis degree of 88 wt %, 4 wt % aqueous solution of which has a viscosity of 4 mPa-s at 20° C. according to DIN 53015, is prepared into a 20 wt % aqueous solution before use.

PVOH 25/88 10.3 wt % aqueous solution, having an hydrolysis degree of 88 wt %, 4 wt % aqueous solution of which has a viscosity of 25 mPa-s at 20° C. according to DIN 53015, is prepared into a 10.3 wt % aqueous solution before use.

PVOH 17/99 10 wt % aqueous solution, having an hydrolysis degree of 99 wt %, 4 wt % aqueous solution of which has a viscosity of 17 mPa-s at 20° C. according to DIN 53015, is prepared into a 10 wt % aqueous solution before use.

EDTA-2Na 8 wt % aqueous solution refers to fEDTA-2Na, which is prepared into a 10 8% aqueous solution before use.

FeAS 10 wt°/0 aqueous solution refers to ferrous ammonium sulfate, which is prepared into a 10 wt % aqueous solution before use.

tBHP 10 wt % aqueous solution refers to t-butyl hydroperoxide, which is prepared into a 10 wt % aqueous solution before use.

FF6 5 wt % aqueous solution refers to disodium hydroxysulfinoacetate (purchased from BrUggemann Chemical Incorporates), whcih is prepared into a 5 wt % aqueous solution before use.

### Preparation

Step 1. Add deionized water, PVOH 25/88 10.3 wt % aqueous solution, PVOH 17/99 10 wt°/0 aqueous solution, FAS into a 5-liter reactor.

Heat the reactor to 70° C., add the first part of vinyl acetate and ethylene, and keep the reactor pressure below 45 bar.

The temperature is raised to 70° C., and the 10 wt°/0 tert-butyl hydroperoxide aqueous solution and 5 wt % FF6 aqueous solution are added dropwise with a pump at the same time, and then the reaction is initiated and the dripping continues until the reaction is complete. The reaction was initiated to increase the temperature to 85° C., and the second part of vinyl acetate and ethylene gas was continuously added, and the pressure of the reactor was maintained at about 58 bar.

Step 2. After 4 hours of reaction, transfer to a degassing tank, continue to add 10 wt°/0 tert-butyl hydroperoxide aqueous solution and 5 wt % FF6 aqueous solution dropwise, then add defoamer, pH adjuster, degas for 30 minutes and discharge the material. Aqueous polymer dispersion is obtained. The Tg of this product is between 0-5° C.; the solid content is between 54-60 wt %.

With reference to the above steps and the material components in Table 1, the examples and comparative examples were prepared.

TABLE 1

| | Ex.1 | Ex.2 | C.Ex.1 | C.Ex.2 | C.Ex.3 | C.Ex.4 |
|---|---|---|---|---|---|---|
| VAM | 82.77 | 82.77 | 82.77 | 82.77 | 82.77 | 82.77 |
| Ethylene | 17.23 | 17.23 | 17.23 | 17.23 | 17.23 | 17.23 |
| PVOH 25/88 | 1.50 | 1.50 | 2.73 | 3.61 | | |
| pure material | | | | | | |
| PVOH 17/99 | 0.49 | | | | 3.61 | |
| pure material | | | | | | |
| PVOH 04/88 | | | 0.96 | | | 3.69 |
| pure material | | | | | | |
| EDTA-2Na | 0.11 | 0.11 | 0.11 | 0.11 | 0.11 | 0.11 |
| (8 wt % solution) | | | | | | |
| FeAS (10 wt % | 0.11 | 0.11 | 0.11 | 0.11 | 0.11 | 0.11 |
| solution) | | | | | | |
| tBHP (10 wt % | 4.84 | 4.84 | 4.84 | 4.84 | 4.84 | 4.84 |
| solution) | | | | | | |
| FF6 (5 wt % | 9.26 | 9.26 | 9.26 | 9.26 | 9.26 | 9.26 |
| solution) | | | | | | |
| defoamer | 4.69 | 4.69 | 4.69 | 4.69 | 4.69 | 4.69 |

*The amount of ethylene in Table 1 refers to the amount of ethylene gas fed in each case.

It is unable to form a uniform aqueous dispersion in comparative examples C.Ex.3. Stable aqueous dispersions could be obtained in Examples Ex.1-2 and comparative examples C.Ex.1-2,4. When stored at 23° C. for 60 days, the viscosity change of C.Ex.1-2,4 is less than 100%.

TABLE 2.1
cotton to cotton 160° C./1 min ironing machine

| | Ex.1 | Ex.2 | C.Ex.1 | C.Ex.2 | C.Ex.3 | C.Ex.4 |
|---|---|---|---|---|---|---|
| dry bonding strength (N) | 50 | 33.4 | 48.3 | 46.6 | / | 44.50 |
| wet bonding strength (N) | 30.8 | 30.1 | 10.5 | 9.8 | / | 9.20 |
| retension | 61.60% | 90.12% | 21.74% | 21.03% | / | 20.67% |

In Table 2.1, the retention rate of the sample is greater than 50%, indicating its excellent water resistance. The samples obtained by Ex.1 and Ex.2 have high wet bonding strength, both greater than 15N. More preferably, the dry bond strength of the sample using Ex.1 is also greater than 40N, and the comprehensive performance is very good.

TABLE 2.2
PU foam to polyester fabric 130° C./1 min ironing machine

| | Ex.1 | Ex.2 | C.Ex.1 | C.Ex.2 | C.Ex.3 | C.Ex.4 |
|---|---|---|---|---|---|---|
| dry bonding | >7 | >7 | >7 | >7 | / | >7 |
| strength (N) | | | | | | |
| wet bonding | >7 | >7 | 1.5 | 1.2 | / | 0.90 |
| strength (N) | | | | | | |

In Table 2.2, the dry bond strength greater than 7 indicates that the body of the polyurethane foam has been damaged. At this time, the interface bonding strength is greater than the body strength of the polyurethane foam. The samples obtained from Ex.1 and Ex.2 have high wet bonding strength and excellent water resistance.

1-10. (canceled)

11. An aqueous polymer dispersion, comprising:
a component (a) of one or more ethylene-vinyl ester copolymers;
a component (b) of one or more protective colloids;
optional a component (c1) of one or more nonionic surfactants;
optional a component (c2) of one or more ionic surfactants;
wherein a total amount of the component (b) of one or more protective colloids is less than or equal to 2.2 pphm, preferably between 1-2.2 pphm, or more preferably 1.8 pphm; and
wherein a total amount of the component (c1) of one or more nonionic surfactants and the component (c2) of one or more ionic surfactants is less than 0.1 pphm, preferably less than or equal to 0.01 pphm.

12. The aqueous dispersion of claim 11, wherein the component (b) of one or more protective colloids comprises a component (b1) of partially hydrolysis polyvinyl alcohol and a component (b2) of fully hydrolysis polyvinyl alcohol.

13. The aqueous dispersion of claim 12, wherein a total amount of the component (b1) of partially hydrolysis polyvinyl alcohol and the component (b2) of fully hydrolysis polyvinyl alcohol is less than or equal to 3.4 pphm, preferably between 1-3.4 pphm, more preferably between 2-3.1 pphm, and more preferably between 2.3-2.9 pphm.

14. The aqueous dispersion of claim 12, wherein the weight ratio of an amount of the component (b1) of partially hydrolysis polyvinyl alcohol to an amount of the component (b2) of fully hydrolysis polyvinyl alcohol is between 0.8-4, preferably between 1.01-3, more preferably between 1.05-1.9.

15. The aqueous dispersion of claim 12, wherein an amount of the component (b1) of partially hydrolysis polyvinyl alcohol is less than or equal to 2 pphm, preferably less than or equal to 1.6 pphm, and more preferably between 1.1-1.7 pphm.

16. The aqueous dispersion of claim 12, wherein an amount of the component (b2) of fully hydrolysis polyvinyl alcohol is less than or equal to 1.5 pphm, preferably less than or equal to 1.3 pphm, more preferably between 0.3-1.1 pphm.

17. The aqueous dispersion of claim 11, wherein the aqueous dispersion is used for interfacial bonding between polymeric porous materials.

18. The aqueous dispersion of claim 11, wherein the aqueous dispersion is used for improving water resistance at the bonding interface of polymer porous materials.

19. The aqueous dispersion of claim 11, wherein the aqueous dispersion is used for improving wet bonding strength at the bonding interface of polymer porous materials.

20. The aqueous dispersion of claim 11, wherein the aqueous dispersion is used for bonding between textile materials and non-woven materials.
